(19) United States
(12) Patent Application Publication
(10) Pub. No.: US 2009/0031759 A1
(43) Pub. Date: Feb. 5, 2009

(54) Gas Supply Assembly For Mineral Fiber Apparatus

(76) Inventors: Michael E. Evans, Granville, OH (US); John Hasselbach, Granville, OH (US)

Correspondence Address: OWENS CORNING, 2790 COLUMBUS ROAD, GRANVILLE, OH, 43023, US

(21) Appl. No.: 12/185,258

(22) Filed: Aug. 4, 2008

Related U.S. Application Data
(60) Provisional application No. 60/963,057, filed on Aug. 2, 2007.

(51) Int. Cl. C03B 37/085; C03B 37/04

(52) U.S. Cl. 65/525; 65/470; 65/460

(57) ABSTRACT

An apparatus for making mineral fibers is provided. The apparatus comprises a rotary fiberizer capable of receiving molten mineral material and centrifuging the molten mineral material into mineral fibers. A fiberizer burner is connected to the rotary fiberizer. The fiberizer burner is configured to receive a first flow of combustion gas and burn the first flow of combustion gas to support the making of the mineral fibers. A gas supply assembly is configured to supply the fiberizer burner with the first flow of combustion gas. The gas supply assembly comprises a pilot assembly having a pilot burner. The pilot burner is operable to burn a pilot flame from a second flow of combustion gas. The pilot flame is operable to ignite the first flow of combustion gas flowing to the fiberizer burner. A flame sensor is operable to detect a change in the pilot flame and communicate the change in the pilot flame. A controller is configured to communicate with the flame sensor and control the first flow of combustion gas to the fiberizer burner and the second flow of combustion gas to the pilot assembly.

### RELATED APPLICATIONS

This application claims the benefit of U.S. Provisional Application No. 60/963,057, filed Aug. 2, 2007, the disclosure of which is incorporated herein by reference.

### TECHNICAL FIELD

This invention relates in general to the production of mineral fiber material, particularly of such materials as glass fiber. More particularly, this invention relates to controlling the flow of combustion gases to burners and pilot flames used in the production of mineral fibers.

### BACKGROUND OF THE INVENTION

In the manufacture of mineral fiber insulation, the mineral fibers are usually formed from molten mineral material using fiberizers. In a typical manufacturing operation, the molten mineral material is introduced into a plurality of fiberizers. The molten material is generated in a melter or furnace and is delivered to the fiberizers by way of a forehearth having a series of bushings. The fiberizers centrifuge the molten material and cause the material to be formed into fibers that are directed as a stream or veil to a collection unit.

As the newly formed fibers exit the fiberizer, the fibers are maintained in a plastic, attenuable condition by heat supplied from an annular burner. High speed gases from an annular blower force the fibers downward toward a collection operation. The burner utilizes a flow of gas that is ignited by a pilot light assembly and regulated by one or more control valves. In some production facilities the control valves are manually operated and in other production facilities the control valves are automatically controlled. It would be advantageous if improvements could be made to the control valves.

### SUMMARY OF THE INVENTION

According to this invention there is provided an apparatus for making mineral fibers. The apparatus comprises a rotary fiberizer capable of receiving molten mineral material and centrifuging the molten mineral material into mineral fibers. A fiberizer burner is connected to the rotary fiberizer. The fiberizer burner is configured to receive a first flow of combustion gas and burn the first flow of combustion gas to support the making of the mineral fibers. A gas supply assembly is configured to supply the fiberizer burner with the first flow of combustion gas. The gas supply assembly comprises a pilot assembly having a pilot burner. The pilot burner is operable to burn a pilot flame from a second flow of combustion gas. The pilot flame is operable to ignite the first flow of combustion gas flowing to the fiberizer burner. A flame sensor is operable to detect a change in the pilot flame and communicate the change in the pilot flame. A controller is configured to communicate with the flame sensor and control the first flow of combustion gas to the fiberizer burner and the second flow of combustion gas to the pilot assembly.

According to this invention there is also provided an apparatus for making mineral fibers. The apparatus comprises a rotary fiberizer capable of receiving molten mineral material and centrifuging the molten mineral material into mineral fibers. A fiberizer burner is connected to the rotary fiberizer. The fiberizer burner is configured to receive a first flow of combustion gas and burn the first flow of combustion gas to support the making of the mineral fibers. A gas supply assembly is configured to supply the fiberizer burner with the first flow of combustion gas. The gas supply assembly comprises a pilot assembly having a pilot burner. The pilot burner is operable to burn a pilot flame from a second flow of combustion gas. The pilot flame is operable to ignite the first flow of combustion gas flowing to the fiberizer burner. A flame sensor is operable to detect a change in the pilot flame and communicate the change in the pilot flame. A controller is configured to communicate with the flame sensor and control the first flow of combustion gas to the fiberizer burner and the second flow of combustion gas to the pilot assembly. The controller shuts off the first and second flows of combustion gas in the event of an upset condition.

According to this invention there is also provided a method of making mineral fibers comprising the steps of: providing a rotary fiberizer capable of receiving molten mineral material and centrifuging the molten mineral material into mineral fibers, connecting a fiberizer burner to the rotary fiberizer, the fiberizer burner configured to receive a first flow of combustion gas and burn the first flow of combustion gas to support the making of the mineral fibers, providing a gas supply assembly configured to supply the fiberizer burner with the first flow of combustion gas, the gas supply assembly comprising, a pilot assembly having a pilot burner, the pilot burner operable to burn a pilot flame from a second flow of combustion gas, the pilot flame operable to ignite the first flow of combustion gas flowing to the fiberizer burner, a flame sensor operable to detect a change in the pilot flame and communicate the change in the pilot flame, a controller configured to communicate with the flame sensor and control the first flow of combustion gas to the fiberizer burner and the second flow of combustion gas to the pilot assembly, sensing a change in the pilot flame, communicating the change in the pilot flame to the controller, and controlling the first and second flows of combustion gas in response to the sensed change in the pilot flame.

Various advantages of this invention will become apparent to those skilled in the art from the following detailed description of the invention, when read in light of the accompanying drawings.

### BRIEF DESCRIPTION OF THE DRAWINGS

FIG. 1 is a schematic representation in elevation of an apparatus for manufacturing glass fibers.

FIG. 2 is a schematic representation in elevation of an apparatus for manufacturing glass fiber insulation material.

FIG. 3 is a partial cross-sectional elevational view of the fiberizer of the apparatus illustrated in FIGS. 1 and 2.

FIG. 4 is a side view in elevation of the gas supply assembly of the apparatus of FIGS. 1 and 2.

FIG. 5 is a partial cross-sectional elevational view of the pilot assembly and flame sensor of the apparatus of FIGS. 1 and 2.

### DETAILED DESCRIPTION OF THE INVENTION

For the purposes of simplicity and clarity, the invention will be described in terms of glass fiber manufacturing, but the inventive method and apparatus are applicable as well to the manufacture of fibrous products of other mineral materials, such as rock, slag and basalt.

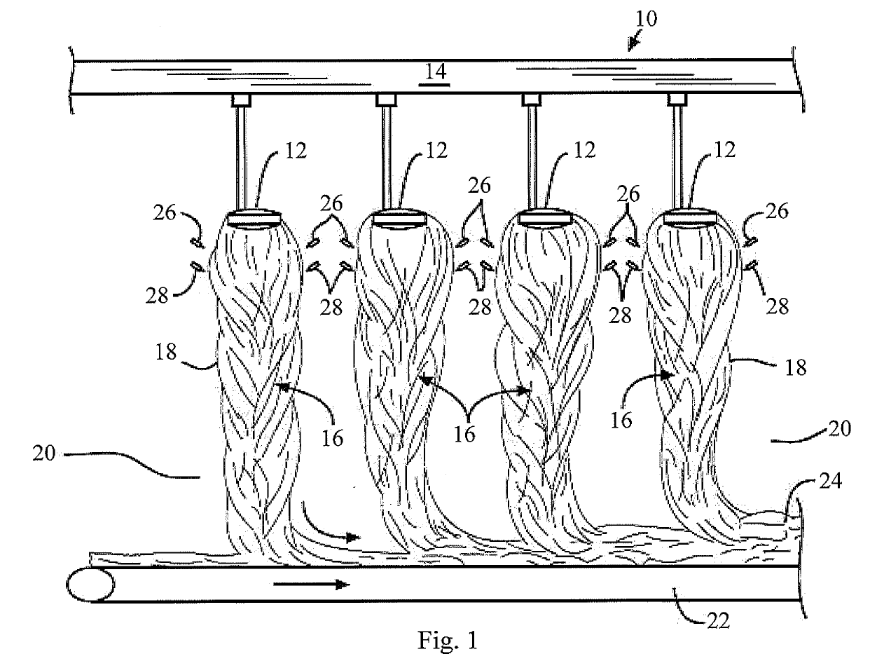

A glass fiberizing apparatus 10 for producing glass fibers is shown in FIG. 1. While FIG. 1 illustrates a glass fiberizing apparatus 10 for producing glass mats or glass blankets, it should be appreciated that the invention can be used for producing other forms of glass fiber based material, such as for example chopped glass fibers. Examples of glass fiberizing apparatus include U.S. Pat. No. 5,474,590 to Lin, U.S. Pat. No. 4,831,746 to Kim, U.S. Pat. No. 4,537,610 to Armstrong, U.S. Pat. No. 4,280,253 to Holt, and U.S. Pat. No. 4,263,033 to Michalek, all of which are incorporated herein by reference. Referring again to FIG. 1, a plurality of fiberizers 12 receives molten glass material from a forehearth 14. The plurality of fiberizers 12 generate veils 16 of glass fibers 18 and hot gases. In the embodiment shown in FIG. 1, the veils 16 are directed downward through a chamber or forming hood 20, and onto a foraminous collecting conveyer 22, which gathers the glass fibers 18 into a continuous mat or blanket 24. The travel of the veils 16 through the forming hood 20 enables the glass fibers 18 and accompanying hot gases to cool considerably by the time they reach the conveyor 22. Typically, the glass fibers 18 and gases reaching the conveyor 22 are at a temperature no greater than about 300 degrees Fahrenheit. Water sprayers 26 spray fine droplets of water onto the hot gases in the veil 16 to help cool the flow of hot gases. Binder sprayers 28, positioned beneath the water sprayers 26, are used to direct a resinous binder onto the downwardly moving glass veils 16.

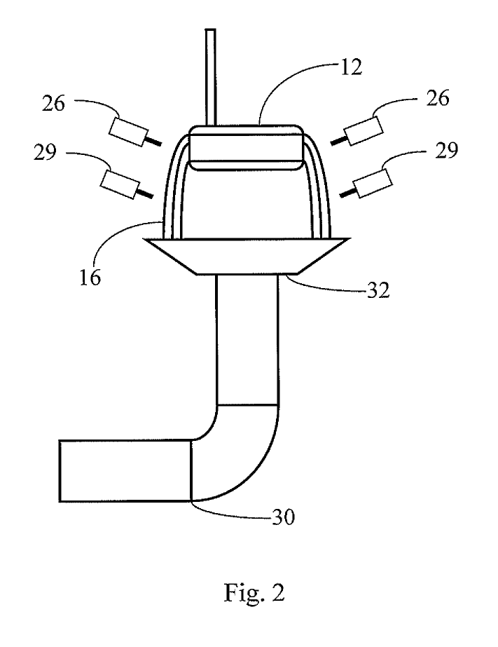

While the embodiment shown in FIG. 1 illustrates the forming of a continuous mat or blanket 24, in another embodiment as shown in FIG. 2, the veils 16 can be used to manufacture loose fill insulation. In this embodiment, a plurality of fiberizers 12 form the veils 16 from the glass fibers 18 as described above. Although only one fiberizer 12 is shown, it is to be understood that any number of fiberizers 12 can be employed. As further shown in FIG. 2, water sprayers 26 spray fine droplets of water onto the hot gases in the veil 16 to help cool the flow of hot gases. However, in this embodiment, there are no binder materials applied to the glass fibers 18 formed by each fiberizer 12. Instead, a lubricant material, such as a silicone compound or an oil emulsion, for example, can be applied to the glass fibers 18 by lubricant sprayers 29. Application of a lubricant material to the glass fibers 18 prevents damage to the glass fibers 18 as they move through downstream manufacturing apparatus (not shown) and come into contact with apparatus components as well as other glass fibers 18. The lubricant will also be useful to reduce dust in the ultimate product. Typically, the final glass wool product contains about 1 percent oil by weight, although other concentrations can be used.

Once the lubricant material is applied to the glass fibers 18, an entrance 32 to a gathering member 30 receives the glass fibers 18. The gathering member 30 is adapted to receive both the glass fibers 12 and the accompanying flow of hot gases in the veil 16. The downward flow of gases in the veil 16 is created by an annular blower (not shown) and an annular burner (also not shown) connected with the fiberizer 12. The momentum of the flow of gases will cause the glass fibers 18 to continue to move through the gathering member 30 to downstream manufacturing operations (not shown).

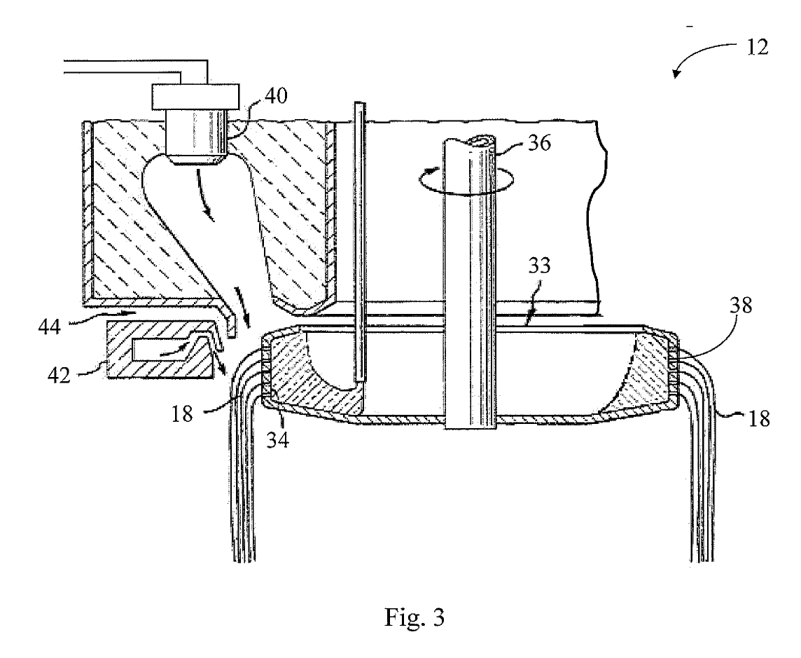

As shown in FIG. 3, each fiberizer 12 includes a spinner 33 having a spinner peripheral wall 34. Examples of fiberizers 12 and spinners 33 include U.S. Pat. No. 4,246,017 to Phillips, U.S. Pat. No. 5,474,590 to Lin, U.S. Pat. No. 5,582,841 to Watton et al., U.S. Pat. No. 5,785,996 to Snyder, and U.S. Pat. No. 4,246,017 to Phillips, all of which are incorporated herein by reference. Referring again to FIG. 3, each spinner 33 rotates on a spindle 36. The rotation of the spinner 33 centrifuges molten glass through orifices 38 in the spinner peripheral wall 34 to form glass fibers 18. The glass fibers 18 are maintained in a soft, attenuable condition by the heat of a fiberizer burner 40. Optionally, another burner or burners (not shown) may be also used to provide heat to the interior of the fiberizer 12. A blower 42, using induced air through passage 44, is positioned to pull and further attenuate the glass fibers 18. While the fiberizer burner 40 and the blower 42 shown in FIG. 3 are configured in the illustrated positions relative to the spinner 33, it should be appreciated that the fiberizer burner 40 and the blower 42 can be configured in other positions relative to the spinner 33.

In the embodiment shown in FIG. 3, the fiberizer burner 40 provides heat to the fiberizer 12 through the combustion of gases. In one embodiment, the gases can be a mixture of gasses, such as for example a mixture of fuel gas and air. Alternatively the mixture of gases can be another mixture suitable for combustion, such as for example fuel gas and oxygen.

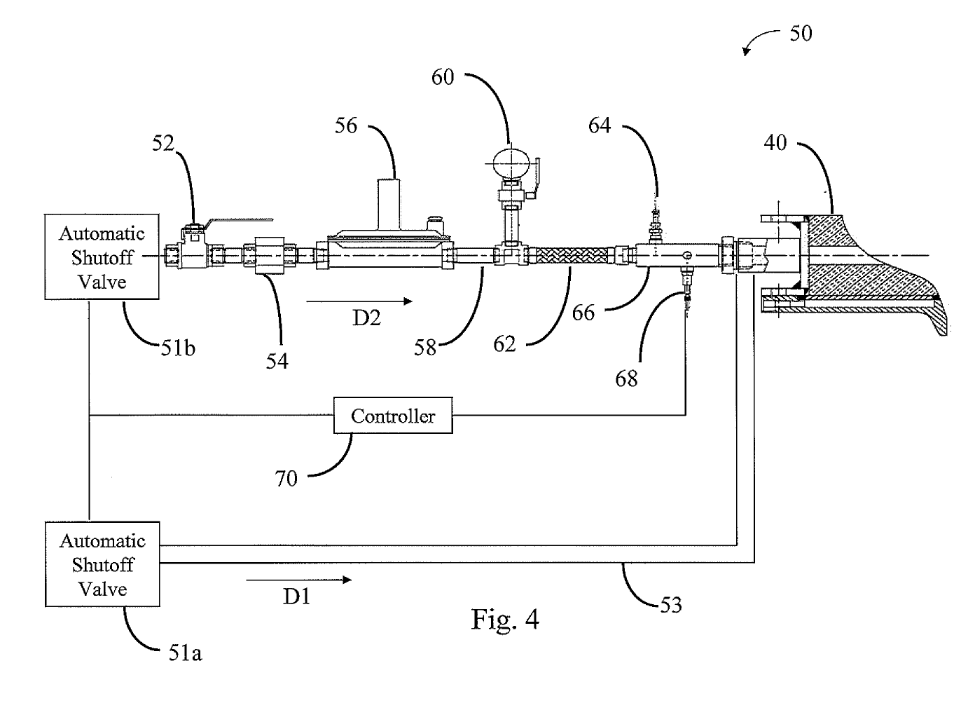

Referring now to FIG. 4, the first automatic shutoff valve 51a controls the first flow of combustion gases through a burner supply pipe 53 to the fiberizer burner 40. The burner supply pipe 53 is configured for a pipe having an inside diameter in a range of from about 3.00 inches to about 5.00 inches. In another embodiment the pipe can have an inside diameter of less than about 3.00 inches or more than about 5.00 inches.

As generally shown in FIG. 4, a gas supply assembly 50 controls a first flow of combustion gases in direction D1 and a second flow of combustion gases in direction D2. The first flow of combustion gases is used to supply the fiberizer burner 40. The first flow of combustion gases is controlled by a first automatic shutoff valve 51a. A second flow of combustion gas is used to maintain a pilot flame within a pilot assembly 64. The second flow of combustion gases is controlled by a second automatic shutoff valve 51b. As will be described later in more detail, the first and second automatic shutoff valves, 51a and 51b, are controlled by a controller 70 and are configured to shut off the first flow of combustion gas to the fiberizer burner 40 and the second flow of combustion gas to the pilot assembly 64 in the event of an upset condition. The term “upset condition” is defined to mean any condition that potentially affects the ignition of the first and second flows of combustion gases within the fiberizer burner 40 and the pilot assembly 64. Examples of upset conditions include natural disasters, power failures, machinery malfunctions and human error.

In general, the gas supply assembly 50 is configured to perform several functions including: regulating the second flow of combustion gases to the pilot assembly 64, igniting the first flow of combustion gases flowing to the fiberizer burner, and detecting and sensing the condition of a pilot flame within the combustion tube 66. As illustrated in FIG. 4, the gas supply assembly 50 is configured for a pipe having an inside diameter in a range from about 0.375 inches to about 1.5 inches. In another embodiment, the pipe can have an inside diameter of less than about 0.375 inches or more than about 1.5 inches.

The gas supply assembly 50 includes an optional first valve 52. The optional first valve 52 is configured to provide a master on/off valve for the second flow of combustion gases to the pilot assembly 64. In normal operation, the first valve 52 is maintained in an open position. In the illustrated embodiment, the first valve 52 is a manually operated ball valve. Alternatively, the first valve 52 can be another type of valve sufficient to provide a master on/off valve for the second flow of combustion gases. In other embodiments, the gas supply assembly 50 can be operated without the first valve 52.

The optional first valve 52 is connected to a regulator valve 56 by a first connector 54. The first connector 54 is configured to provide a gas-tight connection between the first valve 52 and the regulator valve 56. In the illustrated embodiment, the first connector 54 is a male×male union. In another embodiment, the first valve 52 can be connected to the regulator valve 56 by another type of connector sufficient to provide a gas-tight connection.

The regulator valve 56 is configured to reduce or increase the pressure of the incoming second flow of combustion gas and provide a desired outlet pressure of the second flow of combustion gas to downstream operations. Regulator valves are commercially available, such as for example, the Maxitrol Model 325-3 Lever Acting Design from Maxitrol Company in Southfield, Mich. However, other regulator valves 56 can be used. In the illustrated embodiment, the pressure of the incoming second flow of combustion gas is in a range from about 20-25 in H₂O and the outlet pressure is in a range from about 2-4 in H₂O.

The regulator valve 56 is connected to an optional pressure gauge 60 by a pipe connector 58. The pipe connector 58 is configured to provide a gas-tight connection between the regulator valve 56 and the pressure gauge 60. In the illustrated embodiment, the pipe connector 58 has male threads on each end. In another embodiment, the regulator valve 56 can be connected to the pressure gauge 60 by another type of connector sufficient to provide a gas-tight connection.

The outlet pressure of the second flow of combustion gas is monitored by an optional pressure gauge 60. Pressure gauges are commercially available, such as for example, the Ashcroft Model 1490A Low Pressure Diaphragm Gauge from Ashcroft Corporation Stratford, Conn. However, other pressure gauges 60 can be used. In other embodiments, the gas supply assembly 50 can be operated without the pressure gauge 60.

In the illustrated embodiment shown in FIG. 4, the optional pressure gauge 60 is connected to a pilot assembly 64 by a flexible connector 62. The flexible connector 62 is configured to provide a gas-tight flexible connection between the pressure gauge 60 and the pilot assembly 64. In the illustrated embodiment, the flexible connector 62 is a stainless-steel, braided, gas rated flexible hose. In another embodiment, the pressure gauge can be connected to the pilot assembly 64 by another type of connector sufficient to provide a flexible gas-tight connection. In yet another embodiment, the pressure gauge 60 can be connected to the pilot assembly 64 by a rigid connector, such as for example a union or a segment of threaded pipe, sufficient to provide a gas tight connection between the pressure gauge 60 and the pilot assembly 64.

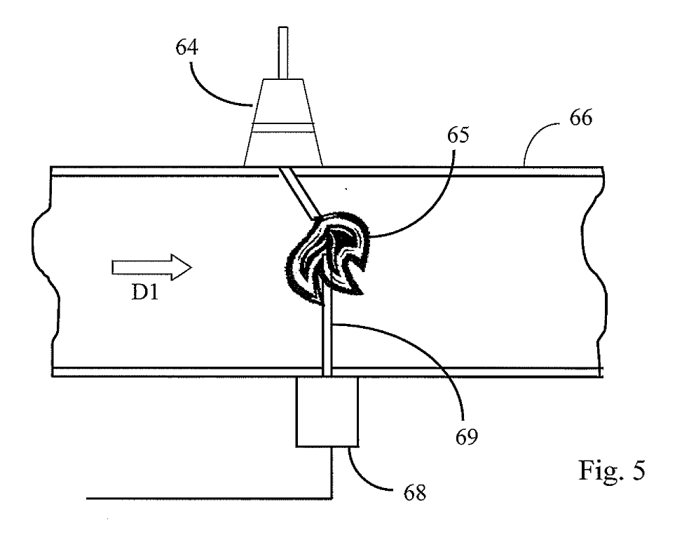

The first flow of combustion gas is ignited at the fiberizer burner 40 by the pilot assembly 64. The pilot assembly 64 is configured to provide a small gas powered pilot flame 65 within a combustion tube 66, as shown in FIG. 5. The pilot flame 65 is kept alight in order to serve as an ignition source for the first flow of combustion gas. Pilot assemblies are commercially available, such as for example, the Bloom Model No. 3001-202-04 from Bloom Engineering Company, Inc. in Pittsburgh, Pa. However, other pilot assemblies 64 and other pilot mechanisms can be used.

As shown in FIGS. 4 and 5, the pilot assembly 64 is connected to the combustion tube 66. A flame sensor 68 is also connected to the combustion tube 66. The flame sensor 68 includes a flame rod 69. The flame sensor 68 is configured such that the flame rod 69 is positioned within the flame envelope of the pilot flame 65. The flame rod 69 is configured to detect the presence of the pilot flame 65 within the combustion tube 66. In the illustrated embodiment the flame rod 69 detects the presence of the pilot flame 65 within the combustion tube 66 by the electric current rectification properties of the pilot flame 65. Alternatively, the flame rod 69 can detect the presence of the pilot flame 65 within the combustion tube 66 using other methods, such as for example detecting the heat produced by the pilot flame 65 or detecting the envelope of the pilot flame 65. Flame sensors 68 are commercially available, such as for example, the Honeywell Model No. C7007A from Honeywell Inc. in Golden Valley, Minn. However, other pilot flame sensors 68 can be used. The flame sensor 68 is further configured to provide a signal to the controller 70 verifying the presence of the pilot flame 69 within the combustion tube 66.

In operation, the second automatic shutoff valve 51b allows a flow of combustion gases to the pilot assembly 64. The second flow of combustion gas is pressure regulated by the pressure regulator 56. The pilot flame 65 within the combustion tube 66 is lit. The presence of the pilot flame 65 is detected by the flame rod 69 of the flame sensor 68. The flame sensor 68 generates a signal indicating the presence of the pilot flame 65 within the combustion tube 66. The signal from the flame sensor 68 is communicated to the controller 70. The controller 70 operates the first automatic shutoff valves 51a, allowing the first flow of combustion gas to flow through the burner supply pipe 53 to the fiberizer burner 40. The first flow of combustion gas through the burner supply pipe 53 is ignited by the pilot flame 65 within the pilot assembly 64 and the fiberizer burner 40 provides heat to the fiberizer 12. In the event of an upset condition, the flame rod 69 of the flame sensor 68 senses a change in the pilot flame 65. The change in the pilot flame 65 generates a signal which is communicated from the flame sensor 68 to the controller 70. The controller 70 communicates with the first and second automatic shutoff valves, 51a and 51b, to stop the first flow of combustion gas to the fiberizer burner 40 and the second flow of combustion gas to the pilot assembly 64. As described above, the controller 70 is configured to receive signals from the flame sensor 68 and subsequently communicate with the first and second automatic shutoff valves, 51a and 51b, to step the first flow of combustion gas to the fiberizer burner 40 and the second flow of combustion gas to the pilot assembly 64. In the illustrated embodiment, the controller 70 is a microprocessor-based device such as for example a programmable logic controller. In other embodiments, the controller 70 can be other devices, such as for example a laptop computer, sufficient to receive signals from the flame sensor 68 and subsequently communicate with the first and second automatic shutoff valves, 51a and 51b, to stop the first flow of combustion gas to the fiberizer burner 40 and the second flow of combustion gas to the pilot assembly 64. In the illustrated embodiment, the controller 70 is configured to receive communication from the flame sensor 68 as to the condition of the pilot flame 65. In other embodiments, the controller 70 can initiate communication to the flame sensor 68 verifying the condition of the flame sensor 68.

The principle and mode of operation of this invention have been described in its preferred embodiments. However, it should be noted that this invention may be practiced otherwise than as specifically illustrated and described without departing from its scope.

What is claimed is:

1. An apparatus for making mineral fibers comprising:
a rotary fiberizer capable of receiving molten mineral material and centrifuging the molten mineral material into mineral fibers;
a fiberizer burner connected to the rotary fiberizer, the fiberizer burner configured to receive a first flow of combustion gas and burn the first flow of combustion gas to support the making of the mineral fibers;
a gas supply assembly configured to supply the fiberizer burner with the first flow of combustion gas, the gas supply assembly comprising:
a pilot assembly having a pilot burner, the pilot burner operable to burn a pilot flame from a second flow of combustion gas, the pilot flame operable to ignite the first flow of combustion gas flowing to the fiberizer burner;
a flame sensor operable to detect a change in the pilot flame and communicate the change in the pilot flame; and
a controller configured to communicate with the flame sensor and control the first flow of combustion gas to the fiberizer burner and the second flow of combustion gas to the pilot assembly.

2. The gas supply assembly of claim 1, wherein the controller communicates with a plurality of shutoff valves to control the first and second flows of combustion gas.

3. The gas supply assembly of claim 2, in which the first flow of combustion gas is controlled by a first shutoff valve and the second flow of combustion gas is controlled by a second shutoff valve

4. The gas supply assembly of claim 1, in which the controller controls the first and second flows of combustion gas in the event of an upset condition.

5. The gas supply assembly of claim 1, wherein the pilot flame has a flame envelope and the flame sensor has a flame rod, wherein the flame rod is positioned within the flame envelope.

6. The gas supply assembly of claim 1, wherein the change in the pilot flame includes extinguishment of the pilot flame.

7. The gas supply assembly of claim 1, wherein the pilot flame is positioned within a combustion tube.

8. The gas supply assembly of claim 1, wherein the flame sensor detects a change in the pilot flame by the electric current rectification properties of the pilot flame.

9. The gas supply assembly of claim 1, wherein the controller communicates with the pilot assembly to verity the change in the pilot flame.

10. An apparatus for making mineral fibers comprising:
a rotary fiberizer capable of receiving molten mineral material and centrifuging the molten mineral material into mineral fibers;
a fiberizer burner connected to the rotary fiberizer, the fiberizer burner configured to receive a first flow of combustion gas and burn the first flow of combustion gas to support the making of the mineral fibers;
a gas supply assembly configured to supply the fiberizer burner with the first flow of combustion gas, the gas supply assembly comprising:
a pilot assembly having a pilot burner, the pilot burner operable to burn a pilot flame from a second flow of combustion gas, the pilot flame operable to ignite the first flow of combustion gas flowing to the fiberizer burner;
a flame sensor operable to detect a change in the pilot flame and communicate the change in the pilot flame; and
a controller configured to communicate with the flame sensor and control the first flow of combustion gas to the fiberizer burner and the second flow of combustion gas to the pint assembly;
wherein the controller shuts off the first and second flows of combustion gas in the event of an upset condition.

11. The gas supply assembly of claim 10, wherein the controller communicates with a plurality of shutoff valves to control the first and second flows of combustion gas.

12. The gas supply assembly of claim 11, wherein the first flow of combustion gas is controlled by a first shutoff valve and the second flow of combustion gas is controlled by a second shutoff valve.

13. The gas supply assembly of claim 10, wherein the pilot flame has a flame envelope and the flame sensor has a flame rod, wherein the flame rod is positioned within the flame envelope.

14. The gas supply assembly of claim 10, wherein the flame sensor detects a change in the pilot flame by the electric current rectification properties of the pilot flame.

15. The gas supply assembly of claim 10, wherein the controller communicates with the pilot assembly to verify the change in the pilot flame.

16. A method of making mineral fibers comprising the steps of.
providing a rotary fiberizer capable of receiving molten mineral material and centrifuging the molten mineral material into mineral fibers;
connecting a fiberizer burner to the rotary fiberizer, the fiberizer burner configured to receive a first flow of combustion gas and burn the first flow of combustion gas to support the making of the mineral fibers;
providing a gas supply assembly configured to supply the fiberizer burner with the first flow of combustion gas, the gas supply assembly comprising:
a pilot assembly having a pilot burner, the pilot burner operable to burn a pilot flame from a second flow of combustion gas, the pilot flame operable to ignite the first flow of combustion gas flowing to the fiberizer burner;
a flame sensor operable to detect a change in the pilot flame and communicate the change in the pilot flame; and
a controller configured to communicate with the flame sensor and control the first flow of combustion gas to the fiberizer burner and the second flow of combustion gas to the pilot assembly;
sensing a change in the pilot flame;
communicating the change in the pilot flame to the controller; and
controlling the first and second flows of combustion gas in response to the sensed change in the pilot flame.

17. The method of claim of claim 16, wherein the controller communicates with a plurality of shutoff valves to control the first and second flows of combustion gas.

18. The method of claim 17, in which the first flow of combustion gas is controlled by a first shutoff valve and the second flow of combustion gas is controlled by a second shutoff valve.

19. The method of claim 16, in which the controller shuts off the flow of combustion gas in the event of an upset condition.

20. The method of claim 14, wherein the controller communicates with the pilot assembly to verify the change in the pilot flame.
